(19) United States
(12) Patent Application Publication
(10) Pub. No.: US 2013/0275176 A1
(43) Pub. Date: Oct. 17, 2013

(54) RISK ASSESSMENT OF A SUPPLIER OF AN ORGANIZATION

(71) Applicants: Diane M. Brown, Mesa, AZ (US); Betsy S. Deupree, Charlotte, NC (US); Michael Bartholomew, Charlotte, NC (US); Richard Mattingly, Charlotte, NC (US)

(72) Inventors: Diane M. Brown, Mesa, AZ (US); Betsy S. Deupree, Charlotte, NC (US); Michael Bartholomew, Charlotte, NC (US); Richard Mattingly, Charlotte, NC (US)

(73) Assignee: Bank of America Corporation, Charlotte, NC (US)

(21) Appl. No.: 13/447,664

(22) Filed: Apr. 16, 2012

(51) Int. Cl. G06Q 10/00

(52) U.S. Cl. 705/7.28

(57) ABSTRACT

According to one embodiment of the present invention, risk associated with a supplier of an organization may be assessed. A supplier associated with an organization is identified for risk assessment. The risk assessment comprises a plurality of questions where each question has a priority level. A plurality of selections for the supplier associated with the plurality of questions is determined. A respective selection of the plurality of selections is associated with a respective question of the plurality of questions. A plurality of values associated with the plurality of selections is determined. A respective value of the plurality of values is associated with a respective selection of the plurality of selections. Using a processor, a risk score for the supplier is calculated according to the plurality of values and the priority level of each of the plurality of questions.

### TECHNICAL FIELD

This invention relates, in general, to risk assessment and, more particularly, to risk assessment of a supplier of an organization.

### BACKGROUND OF THE INVENTION

Organizations receive goods and/or services from a variety of suppliers. Some suppliers have access to sensitive information of the organization. Additionally, certain suppliers are subject to various governmental regulations and/or industry standards. Moreover, some suppliers have news or media attention that, subsequently, may become associated with the organization. Because of these various issues, organizations may take on varying amounts of risk by receiving goods and/or services from certain suppliers.

### SUMMARY OF EXAMPLE EMBODIMENTS

In accordance with the present invention, disadvantages and problems associated with risk assessment of a supplier may be reduced or eliminated.

According to one embodiment of the present invention, risk associated with a supplier of an organization may be assessed. A supplier associated with an organization is identified for risk assessment. The risk assessment comprises a plurality of questions where each question has a priority level. A plurality of selections for the supplier associated with the plurality of questions is determined. A respective selection of the plurality of selections is associated with a respective question of the plurality of questions. A plurality of values associated with the plurality of selections is determined. A respective value of the plurality of values is associated with a respective selection of the plurality of selections. Using a processor, a risk score for the supplier is calculated according to the plurality of values and the priority level of each of the plurality of questions.

According to another embodiment of the present invention, supplier risk assessment information is generated. A risk score for a supplier associated with an organization is determined according to a plurality of selections associated with a plurality of questions in a risk assessment. It is determined that the supplier will be evaluated in an additional assessment. A plurality of additional questions are generated according to the risk score. An assessment form is generated for the additional assessment that includes the plurality of additional questions.

Certain embodiments of the invention may provide one or more technical advantages. A technical advantage of one embodiment allows an organization to determine the risk associated with utilizing the goods and/or services of a supplier. For example, a banking organization may determine the risk associated with using a software services supplier across the various lines of business within the bank. Another technical advantage of an embodiment allows an organization to ensure that its suppliers comply with the organization's policies and other applicable regulations, standards, and processes. Another technical advantage of an embodiment allows for forecasting risk associated with a supplier before engaging that supplier to provide goods and/or services for an organization. Another technical advantage of an embodiment allows an organization to utilize knowledge already in its possession to determine a risk associated with a supplier. The organization may subsequently determine whether an additional risk assessment of the supplier is necessary.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an exemplary system that assesses the risk associated with using suppliers to provide various goods and/or services.

FIG. 2 illustrates an exemplary method for assessing risk associated with a supplier of an organization.

FIG. 3 illustrates an exemplary embodiment of a graphical user interface operable to display risk-related information associated with a supplier.

FIG. 4 illustrates an exemplary method for generating risk information associated with a supplier to an organization.

FIG. 5 is an exemplary embodiment of an information form used in performing an additional assessment of a supplier.

FIG. 6 is another exemplary embodiment of an information form used in performing an additional assessment of a supplier.

### DETAILED DESCRIPTION OF EXAMPLE EMBODIMENTS

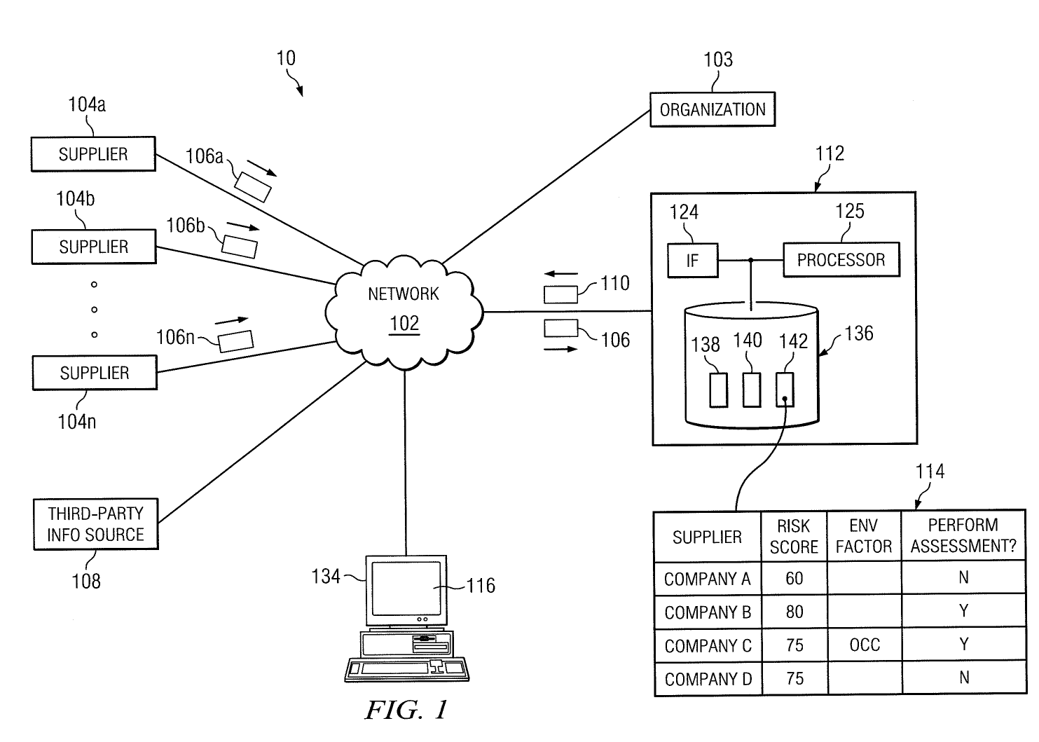

Embodiments of the present invention and its advantages are best understood by referring to FIGS. 1 through 6, like numerals being used for like and corresponding parts of the various drawings.

FIG. 1 illustrates a system 10 that assesses the risk to an organization 103 in using the goods and/or serviced provided by suppliers 104. System 10 also includes third-party information source 108 and administrative computer 134, which communicate with one another and risk assessment module 112 over one or more networks 102. The resulting risk assessment may be used to determine whether organization 103 should begin or maintain services provided by certain suppliers 104, undertake an additional assessment of certain supplier 104, and/or for any other suitable purpose.

Organization 103 represents any suitable type of entity in any suitable industry that requires goods and/or services from a supplier. For example, organization 103 may be a bank, brokerage house, investment firm, consulting firm, insurance agency, law firm, architectural firm, restaurant, retail store, shipping service, manufacturing facility, transportation service, janitorial service, collection agency, printing service, health care facility, or any other suitable entity. In certain embodiments, organization 103 may comprise one or more organizations or business units. For example, if organization 103 is a bank, it may comprise mortgage, consumer real estate, on-line banking, long-term investment, and/or any other suitable business units. As discussed in more detail below, risk assessment module 112 may assess risk of using supplier 104 for the whole of organization 103, a certain organization (i.e., sub-organization) within organization 103, multiple organizations 103, or any suitable combination of the preceding.

A particular supplier 104 represents any suitable type of entity in any suitable type of industry that provides goods and/or services to organization 103. Supplier 104 may be any of the types of entities listed above as possibilities for organization 103. For example, supplier 104a may be a shipping services company and supplier 104b may be a cloud storage company operable to store customer and/or company data in a secure location accessible from the Internet.

Organization 103 may be concerned with various categories of risk involved in utilizing goods and/or services provided by supplier 104. Possible categories of risk relate to information protection and privacy, business continuity, regulatory standards, supply chain protocols, geographic presence, customer contact, subcontractors, and/or any other suitable category of risk.

The information protection and privacy category includes the risk of inappropriate disclosure of information and/or the inadvertent loss of information. For example, whether supplier 104b stores information associated with employees of organization 103 may bear on the information protection and privacy risk category. Various sub-categories for this risk category include protection of customer, employee, or sensitive data; data transmission and access management; physical security; record retention; and/or any other suitable category.

The business continuity category includes the risk that suppliers 104 may not be able to provide goods and/or services because of lack of redundancy, minimal capacity, and/or any other suitable reason. For example, whether a shipping service supplier 104a has backup procedures in place in the event of a failure in the mode of transportation may bear on the business continuity risk category. Various sub-categories for this risk category relate to existence of contingency plans, amount of processing locations, quantity and nature of suppliers that provide goods/services to a particular supplier 104, line of business plan, testing procedures, and/or any other suitable category.

The regulatory standards category includes the risk that procedures and/or equipment used by a particular supplier 104 may violate various regulatory standards required of any applicable entity, such as organization 103 and/or the particular supplier 104. For example, whether credit card information stored by cloud storage supplier 104b has compliance obligations under the Payment Card Industry Data Security Standard (PCI DSS) may bear on the regulatory standards risk category. Various sub-categories for this risk category relate to the particular policy/guidelines required, regulatory impact, financial impact, people/processes/systems required for compliance, previous operational risk assessments, requirements for ongoing reporting of applicable controls, and/or any other suitable category.

The supply chain protocols category includes the risk involved in managing the supply chain of a particular supplier 104. For example, whether shipping services supplier 104a adheres to guidelines specified in a supply chain protocol scorecard may bear on the supply chain protocols risk category. Various sub-categories for this risk category relate to supply chain management participation, existence of negotiated contracts, supply chain protocol tier and rating, requirements for ongoing reporting, and/or any other suitable category.

The geographic presence category includes the risk involved in utilizing a particular supplier 104 that maintains some part of its operations in one or more other countries. For example, whether cloud storage supplier 104b stores information associated with organization 103 in another country may bear on the geographic presence risk category. Various sub-categories for this risk category relate to information protection, remote management of geographically diverse assets, remote assessment of geographically diverse assets, continuity and interactions with geographically diverse assets, and/or any other suitable category.

The customer contact category includes the risk involved when a particular supplier 104 has contact with customers of organization 103. For example, the extent of contact between shipping services supplier 104a and customers of organization 103 may bear on the customer contact risk category. Various sub-categories for this risk category relate to the extent of customer contact, type of customer contact (e.g., in person, email, phone, postal mail), media and reputation, and/or any other suitable category.

The subcontractors category includes the risk involved in the nature of the relationship between a particular supplier 104 and any of its subcontractors. For example, whether cloud storage supplier 104b uses a sole third-party company to manage all the technical support needs of organization 103 may bear on the subcontractors risk category. Various sub-categories for this risk category relate to whether subcontractors are used for services associated with organization 103, control measures in place for subcontractors, and/or any other suitable category.

Data 106 includes information related to a particular supplier 104. Information included in data 106 includes general information associated with supplier 104, information associated with various categories of risk, and/or any other suitable information. In certain embodiments, data 106 includes selections or answers made in response to various risk-related criteria (e.g., questions included in a risk questionnaire) provided by organization 103. In certain embodiments, the selections provided may be chosen from a finite set of possible choices provided by organization 103, freeform responses provided by supplier 104, a non-response (e.g., a blank response or an indication that the answer is unknown), or any other suitable response. Risk assessment module 112 will assess the risk of supplier 104 according to the selections provided in data 106. Data 106 is sent over network 102 to administrative computer 134, risk assessment module 112, or any other location suitable to carry out a risk assessment for supplier 104. Suppliers 104 include any suitable hardware, software, or logic (including a processor) to carry out its reporting operations.

Third party information source 108 represents any source of information that may bear on the risk in utilizing the goods and/or services provided by a supplier 104. Third-party information source 108 may be a financial institution, government agency, credit bureau, news firm, and/or any other suitable information source. The information provided by third-party information source 108 may include certain environmental factors that did not come directly from supplier 104 and/or were learned after the information in data 106 was provided. For example, supplier 104 may be subject to a consent order issued by the Office of the Comptroller of the Currency (OCC) requiring more stringent practices for certain processes. As another example, organization 103 may be the entity subject to an OCC consent order, where a particular supplier 104 provides organization 103 with the services subject to the new requirements. Other examples of environmental factors include results of audits on the practices of supplier 104 and/or organization 103, service areas designated as high risk, changes in the structure of applicable oversight agencies, media attention, customer complaints, news/media/legal settlements, and/or any other suitable factor. Third-party information source 108 includes any suitable hardware, software, or logic (including a processor) to carry out reporting operations to risk assessment module 112 or any other suitable destination.

Network 102 represents any suitable network that facilitates communication between the components of system 10. Network 102 may include any interconnecting system capable of transmitting audio, video, signals, data, messages, or any combination of the preceding. Network 102 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

Risk assessment module 112 may include a network server, any suitable remote server, a mainframe, a host computer, a workstation, a web server, a personal computer, a file, server, or any other suitable device operable to carry out risk assessment operations. In some embodiments, risk assessment module 112 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of risk assessment module 112 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, risk assessment module 112 may include any suitable component that functions as a server.

In certain embodiments, risk assessment module 112 includes a network interface 124, a processor 125, and a memory 136.

Network interface 124 represents any suitable device operable to receive information from network 102, perform suitable processing of the information, communicate to other devices, or any combination of the preceding. For example, network interface 124 may receive a request to perform a risk assessment for a particular supplier 104 from administrative computer 134. As another example, network interface 124 may receive supplier information in the form of data 106 and environmental factors from third-party information source 108. Network interface 124 represents any port or connection, real or virtual, including any suitable hardware and/or software, including protocol conversion and data processing capabilities, to communicate through a LAN, WAN, or other communication systems that allow risk assessment module 112 to exchange information with the components of system 10.

Memory 136 stores, either permanently or temporarily, data, operational software, or other information for processor 125. Memory 136 includes any one or a combination of volatile or nonvolatile local or remote devices suitable for storing information. For example, memory 136 may include random access memory (RAM), read only memory (ROM), magnetic storage devices, optical storage devices, database and/or network storage, removable storage media, or any other suitable information storage device or a combination of these devices. While illustrated as including particular modules, memory 136 may include any suitable information for use in the operation of risk assessment module 112.

In certain embodiments, memory 136 includes management software 138, management data 140, and results data 142. Management software 138 represents any suitable set of instructions, logic, or code embodied in a non-transitory, computer readable medium and operable to facilitate the operation of risk assessment module 112. Management software 138 accesses rules and data stored in management data 140 in order to execute suitable operations.

Management data 140 includes any suitable information regarding the management of risk assessment module 112. For example, management data 140 includes information associated with particular suppliers 104 provided in data 106 and information provided by third party information source 108. As another example, management data 140 includes rules for identifying suppliers 104 to include in a risk assessment. Where organization 103 is a component organization for a larger organization, the list of suppliers for which management data 140 has information may be larger than the list of suppliers relevant to organization 103. Therefore, a rule for identifying suppliers for risk assessment may be to identify those to which organization 103 has previously provided compensation. The amount of money spent with suppliers 104 may also be used to determine whether a certain supplier 104 should be identified for risk assessment.

As another example, management data 140 includes associations for risk-related criteria (e.g., questions provided in a risk questionnaire) with a particular priority level. The priority level indicates whether one question is more, less, or equally as important as another question in the risk questionnaire. In certain embodiments, questions associated with certain risk categories (such as information protection and privacy, regulatory standards, business continuity, and supply chain protocols) may have higher priority levels than questions only associated with certain other risk categories (such as customer contact, geographic presence, and subcontractors).

Management data 140 may also include rules for assigning values (e.g., point values) to the selections made by supplier 104 for each of the questions included in the risk questionnaire. For example, in embodiments where a higher point value indicates higher risk, a supplier 104 that indicates that it uses many subcontractors to provide its services without effective or known oversight of those subcontractors may have a higher point value than a supplier 104 that indicates that it does not use subcontractors to provide its services. Additionally, a blank or otherwise unknown selection for a question on the risk questionnaire represents an unknown risk. In those cases, management data 140 may include a rule that indicates that selections associated with an unknown risk should be assigned a point value representing high risk.

Processor 125 communicatively couples to network interface 124 and memory 136. Processor 125 controls the operation and administration of risk assessment module 112 by processing information received from network interface 124 and memory 136. Processor 125 includes any hardware and/or software that operates to control and process information. For example, processor 125 executes management software 138 to control the operation of risk assessment module 112. In certain embodiments, processor 125 executes instructions to calculate the risk score for a particular supplier 104 according to the priority levels of specific risk-related criteria (e.g., the questions included in a risk questionnaire) and the values assigned to the selections provided by supplier 104 in data 106. As another example, processor 125 executes instructions to check for environmental factors associated with supplier 104 by querying third party information source 108, checking internal audit results of an organization 103, and/or in any other suitable manner. Processor 125 may be a programmable logic device, a microcontroller, a microprocessor, any suitable processing device, or any suitable combination of the preceding.

In one example, suppose the priority level of a question is assigned a number. The selection of a particular supplier 104 for that question is also assigned a number value. For this question, processor 125 multiplies the priority level by the value assigned to the selection for the question. Assuming there are multiple questions, processor 125 performs this operation for each question. Then, the sum of each of these operations is the risk score for the particular supplier. In alternative embodiments, the risk score may be calculated in any suitable manner according to the priority level of the risk-related criteria and the values assigned to the corresponding selections of the supplier.

Results data 142 includes risk scores calculated according to rules and instructions specified in management software 138 and management data 140. In certain embodiments, results data 142 includes a data structure 114 that indicates calculated risk scores for suppliers 104, any applicable environmental factors for each supplier 104, and whether an additional assessment will be performed. In the depicted embodiment, Company A has a risk score of 60, Company B has a risk score of 80, and both Company C and Company D have a risk score of 75. Additionally, risk assessment module 112 has determined that Company C is subject to an OCC consent order, which may require more stringent protocols for its processes. The last column of data structure 114 indicates that risk assessment module 112 recommends that Company B and Company C should have additional assessments. Risk assessment module 112 does not recommend additional assessments for Company A and Company D.

In certain embodiments, risk assessment module may create a ranking of the suppliers 104 included in a risk assessment. The ranking may be built according to risk score, from highest level of risk to lowest level of risk or vice versa. A certain amount of the top-ranked (i.e., highest risk) suppliers may be recommended for additional assessment. A predetermined threshold may exist for the risk score above which risk assessment module 112 will recommend an additional assessment for a particular supplier 114. For example, the embodiment depicted includes a threshold of 78. Because Company B's risk score is greater than the threshold, risk assessment module 112 recommends Company B for additional assessment. Even though Company C has a risk score lower than this threshold, risk assessment module 112 recommends Company C for additional assessment because Company C is subject to an OCC consent order. Risk assessment module 112 may use a secondary threshold for suppliers associated with environmental factors, where this secondary threshold is determined in any suitable manner. For example, the secondary threshold may be set at a predetermined value, such as 70 in the depicted embodiment. In certain embodiments, a secondary threshold may be a function of a primary threshold value, type of environmental factor, the number of environmental factors associated with the particular supplier, and/or any other suitable factor.

Risk assessment module 112 may monitor any factors related to risk assessment of suppliers 104 and automatically recalculate risk scores and/or make different recommendations as to additional assessments in response to changes in those factors. For example, risk assessment module 112 may periodically check third-party information source 108 and/or other various databases for information related to suppliers 104. In certain embodiments, the third-party information source 108 and/or other various databases send information to risk assessment module 112 automatically upon receiving risk-related information associated with suppliers 104. In another example, a particular supplier 104 may submit new data 106, which risk assessment module uses to recalculate the risk score for the particular supplier 104.

Risk assessment module 112 may organize, rank, and/or select certain suppliers 104 for additional assessment according to the specific type of supplier, one or more categories of risk (e.g., information protection and privacy), the existence of environmental factors, the affected organizations, and/or any other suitable factor. In certain embodiments, a person views the recommendations and/or other information provided by risk assessment module of 112 and makes a final determination as to which suppliers 104 to include in an additional assessment.

For a particular supplier 104 chosen for an additional assessment, risk assessment module 112 generates risk assessment information 110. Risk assessment information 110 includes any information suitable for effecting an additional assessment of supplier 104. For example, risk assessment information 110 includes a form with additional questions to be answered for supplier 104. Risk assessment module 112 automatically populates certain fields of the form with information derived from data 106, such as address information, contact name, and/or any other suitable information provided in data 106.

In certain embodiments, management data 140 includes a plurality of possible criteria (e.g., additional questions) that may be determined with respect to suppliers 104 chosen for additional assessment. Risk assessment module 112 includes all or a portion of this criteria in risk assessment information 110. Risk assessment module 112 may choose the criteria to include in risk assessment information 110 according to a total risk score, a risk score for a particular category of risk, an environmental factor, supplier type, and/or any other suitable factor. For example, if a total risk score exceeds a certain threshold, risk assessment information 110 may include questions related to overall risk (e.g., procedures implemented by the supplier 104 to minimize general risk, etc.). As to information included based on a particular category of risk, risk assessment information 110 may include questions specifically tailored to the risk categories for which supplier 104 has high risk scores while excluding questions tailored to risk categories for which supplier 104 has low risk scores. As to environmental factors, risk assessment information 110 may include questions tailored to compliance with OCC consent orders, procedures identified for improvement in an audit, and/or any other suitable question. As another example, risk assessment information 110 may include specific questions tailored to a supplier type associated with supplier 104, such as shipping servicer, food services supplier, website developer, and/or any other suitable supplier type.

The answers/information corresponding to the criteria included in risk assessment information 110 for supplier 104 chosen for additional assessment may be provided directly by supplier 104. In certain embodiments, risk assessment information 110 may be provided to a person who acquires the answers/information corresponding to the criteria included in risk assessment information 110 by performing an on-site or remote risk assessment of supplier 104. The information acquired may be subsequently provided to risk assessment module 112 to generate a new or updated risk score for supplier 104, in the manner previously described. An organization 103 may use the risk score in any suitable manner, such as entering, terminating, or changing the business relationship with supplier 104.

Administrative computer 134 may comprise a network server, any suitable remote server, a mainframe, a host computer, a workstation, a web server, a personal computer, a file, server, or any other suitable device operable to configure and access risk assessment module 112. In some embodiments, administrative computer 134 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 134 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, administrative computer 134 may include any suitable component that functions as a server.

Administrative computer 134 represents any suitable components that facilitate establishment and/or modification of the configuration of any of the components of risk assessment module 112. A user may use administrative computer 134 to create or update the rules used by risk assessment module 112 to determine risk associated with supplier 104. For example, a user may determine the priority level of questions answered by supplier 104 in the initial questionnaire. The user may also determine the value assigned to the selections provided by suppliers 104 in data 106. Administrative computer 134 may also determine which environmental factors risk assessment module 112 should monitor. The user of administrative computer 134 may also be involved in making the final determination as to which suppliers 104 will be subject to an additional assessment based on risk score and environmental factors. In certain embodiments, instead of suppliers 104 providing information as data 106, a user of administrative computer 134 may gather information asked in an initial risk questionnaire by communicating directly with suppliers 104 or by utilizing information from other sources such as third party information source 108. Administrative computer 134 may provide this information as data 106 to risk assessment module 112.

Administrative computer 134 includes a graphical user interface (“GUI”) 116 that displays information received from risk assessment module 112 to the user. GUI 116 is generally operable to tailor and filter data entered by and presented to the user. GUI 116 may provide the user with an efficient and user-friendly presentation of information. For example, GUI 116 may display data structure 114 to the user in a table structure similar to that shown in the depicted embodiment or in any other suitable format. GUI 116 may comprise a plurality of displays having interactive fields, pull-down lists, and buttons operated by the user. GUI 116 may include multiple levels of abstraction including groupings and boundaries. It should be understood that the term GUI 116 may be used in the singular or in the plural to describe one or more GUIs 116 and each of the displays of a particular GUI 116.

In an exemplary embodiment of operation, a user of administrative computer 134 instructs risk assessment module 112 to begin a risk assessment for organization 103. Risk assessment module 112 identifies suppliers 104 for which organization 103 has previously spent money. Data 106, which includes selections made in response to questions in a risk questionnaire, is provided to risk assessment module 112. Some suppliers 104 provide data 106 to risk assessment module 112 directly while administrative computer 134 provides data 106 for other suppliers 104. Risk assessment module 112 determines values to assign to the selections included in data 106 using rules stored in management data 140. Risk assessment module 112 uses the priority levels for each of the questions in the risk questionnaire and the values assigned to the selections to determine a risk score for each of the suppliers 104 included in the risk assessment. Risk assessment module 112 detects environmental factors associated with some of the suppliers 104. Risk assessment module 112 reports the results of the risk assessment to administrative computer 134, which displays the results on GUI 116.

In a particular embodiment, risk assessment module 112 makes a recommendation for supplier 104b to undergo an additional assessment because its risk score exceeds a certain threshold. Risk assessment module 112 recommends supplier 104a for additional assessment because its risk score does exceeds the threshold. As part of the additional assessment, risk assessment module 112 generates risk assessment information 110. Risk assessment information 110 includes follow-up questions specifically tailored to risk categories for which supplier 104a has a high level of risk. Risk assessment information 110 also includes questions tailored to the supplier type for supplier 104a. The user of administrative computer 134 uses risk assessment information 110 to conduct an on-site additional assessment of supplier 104a.

In a particular embodiment, risk assessment module 112 receives updated data 106b for supplier 104b and detects that supplier 104b is subject to an OCC consent order. Risk assessment module 112 determines that 104b should undergo an additional assessment based on the updated risk score and the existence of the OCC consent order. Risk assessment module 112 generates additional risk assessment information 110, which includes certain additional questions because of the total risk score for supplier 104b and because of the OCC consent order. The user of administrative computer 134 uses the additional risk assessment information 110 to conduct a remote additional assessment of supplier 104b.

A component of the system 10 may include an interface, logic, memory, and/or other suitable element. An interface receives input, sends output, processes the input and/or output, and/or performs other suitable operation. An interface may comprise hardware and/or software. Logic performs the operations of the component, for example, executes instructions to generate output from input. Logic may include hardware, software, and/or other logic. Logic may be encoded in one or more non-transitory, such as a computer readable medium or any other tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. The components of the systems and apparatuses may be integrated or separated. For example, risk assessment module 112 may be integrated directly into administrative computer 134. In embodiments with this configuration, risk assessment module 112 may exclude network interface 124. Rather, a user of administrative computer 134 may input information, such as data 106, directly into administrative computer 134. Moreover, the operations of the systems and apparatuses may be performed by more, fewer, or other components. For example, certain embodiments of risk assessment module 112 may rely on environmental factors determined by organization 103 rather than or in addition to information provided by third party information source 108. As an example of this, an internal audit of a process of organization 103 may be associated with a service provided by a particular supplier 104, which is then included in the risk assessment for the particular supplier 104. Additionally, operations of the systems and apparatuses may be performed using any suitable logic comprising software, hardware, and/or other logic.

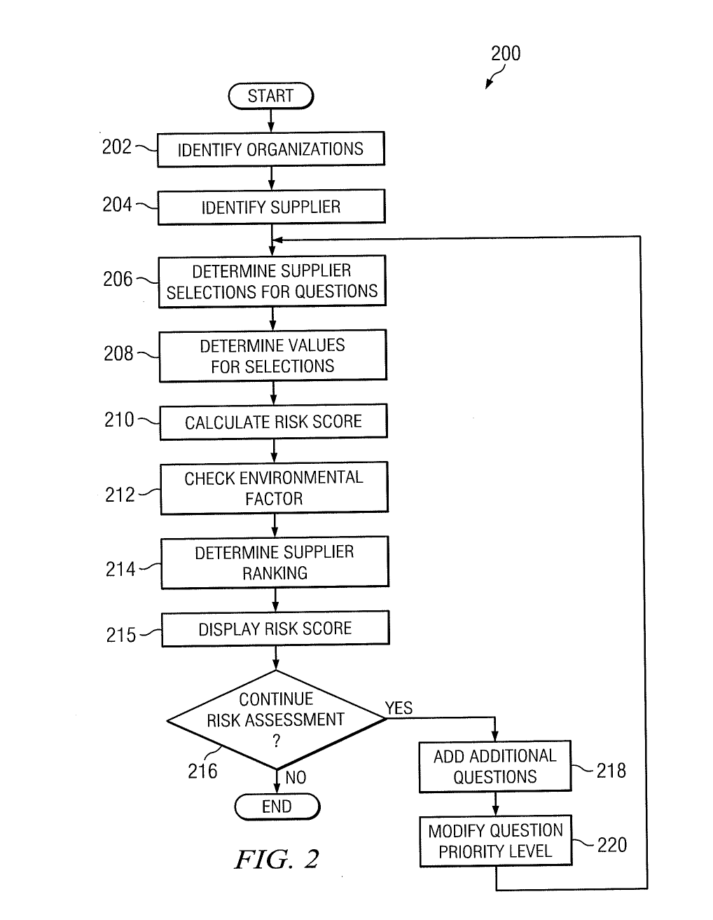

FIG. 2 illustrates an exemplary method 200 for assessing risk associated with a supplier of an organization.

At steps 202 and 204, applicable organizations and suppliers are identified. Specifically, at step 202, the method identifies an organization that receives goods and/or services of one or more suppliers. In certain embodiments, multiple organizations will be identified. At step 204, the supplier that will be included in the risk assessment is identified. Similar to step 202, multiple suppliers may be identified in step 204. The identified supplier may be selected because it has received compensation from or otherwise provided goods and/or services to the organization identified in step 202. In certain embodiments, the identified suppliers are candidate suppliers that the organization identified in step 202 is evaluating for future supply of goods and/or services.

At step 206, the method determines the selections for the identified supplier corresponding to risk-related criteria. The risk related criteria may have been previously provided in the form of a questionnaire provided to the identified suppliers. The selections may be received directly from the identified supplier and/or received from another party, such as an administrator of risk assessment module 112 or an associate of organization 103. The method determines values to assign to the selections at step 206. The values assigned to the selections may depend on the value of inherent risk associated with the selection. In particular embodiments, a selection corresponding to one of the risk-related criteria may be missing and/or unintelligible. In such cases, the value assigned for the selection may represent a value for unknown risk. At step 210, a risk score is calculated for the identified supplier. The risk score is based on the values assigned to the selections and the priority levels assigned to the risk-related criteria. In certain embodiments, the risk score is based on a subset of the selections. For example, the risk score may depend only on selections for the risk-related criteria associated with a particular risk category.

The method checks for environmental factors associated with the identified supplier at step 212. In this step, the method may periodically monitor any suitable information source for information that affects the risk associated with the identified supplier, where the information may not come directly from that supplier. The information obtained in this step may also encompass information learned after determining the selections in step 206. This information may be the results of an audit, procedures required by an OCC consent order, negative news/media attention, and/or any other suitable information.

At step 214, a supplier ranking is created, where the identified suppliers are ranked according to their risk. The ranking may be based on the risk scores, environmental factors, and/or any other suitable information. In certain embodiments, the ranking only includes suppliers from a particular supplier type. For example, the ranking may include only identified suppliers in the shipping services industry. Additionally, the ranking may be automatically recalculated based on any of these factors, such as in response to detecting an environmental factor associated with one of the identified suppliers. Risk score information, ranking, information associated with the identified suppliers, and/or any other suitable information may be displayed at step 215, for example, on GUI 116.

At step 216, the method determines whether the risk assessment should continue. If not, the method ends. Otherwise, the method proceeds with step 218. In this step, additional risk-related criteria (e.g., additional questions) may be added into the existing pool of criteria. For example, an administrator of risk assessment module 112 and/or an associate of organization 103 may add new criteria in order to incorporate different types of risk into the risk assessment.

At step 220, the method modifies the priority level associated with the risk-related criteria. In this step, the criteria may receive different priority levels that account for the importance of the new criteria added in step 218. For example, a new criterion added at step 218 may now have the highest priority of all criteria while all the previously included criteria moves down to the next lower priority level. The method proceeds again to step 206, where previous selections may be updated and new selections are determined for new criteria added in step 218. These updates allow for an updated risk score to be calculated in step 210.

Modifications, additions, or omissions may be made to method 200 disclosed herein without departing from the scope of the invention. The methods may include more, fewer, or other steps. For example, the method may exclude step 202 and assume the same organization is always at issue for the remainder of the steps. As another example, the method may exclude step 214 where only one supplier has been identified or where the multiple suppliers identified are not placed into a ranking. Additionally, steps may be performed in parallel or in any suitable order. For example, the suppliers ranked in step 214 may occur before checking for environmental factors associated with the identified suppliers.

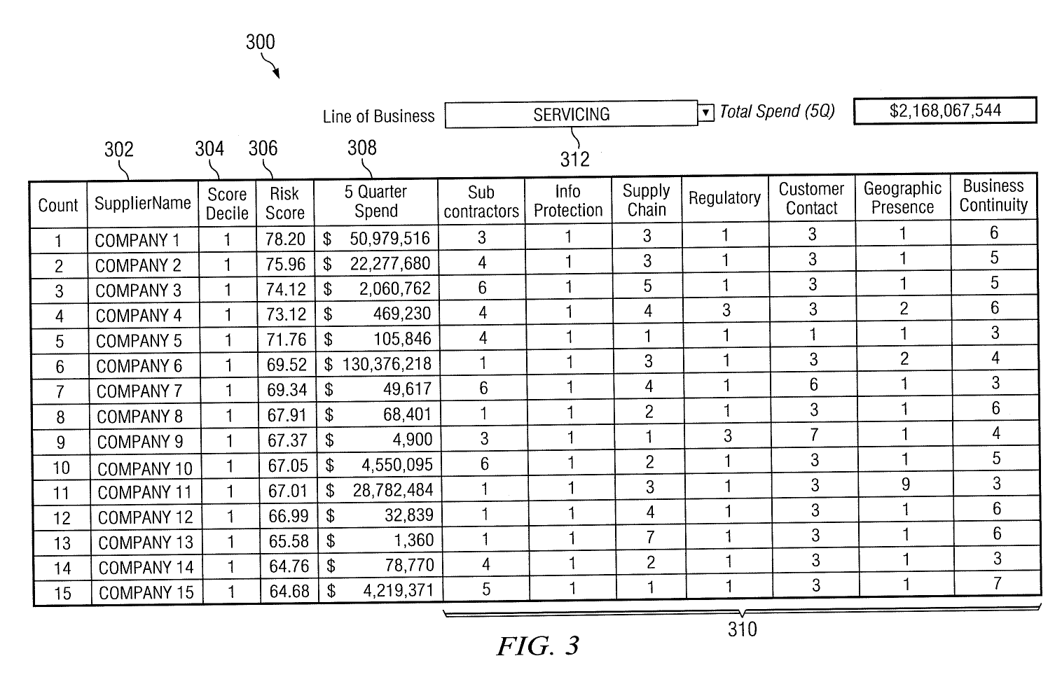

FIG. 3 illustrates an exemplary embodiment of a GUI 300 operable to display risk-related information associated with suppliers 104. In certain embodiments, GUI 300 may be an example of GUI 116 of FIG. 1. Column 302 includes identifiers associated with the suppliers identified for risk assessment. Column 304 includes the decile in which the suppliers reside for an overall risk score. In the depicted embodiment, suppliers residing the first decile in this column have the highest overall level of risk. Other suppliers (not shown) reside in the remaining deciles. Column 306 includes risk scores for the identified suppliers. In the depicted embodiment, higher risk scores indicate a higher level of risk associated with the corresponding supplier. Column 308 displays the amount of money spent with a particular supplier over the previous five quarters. Columns 310 include the deciles in which the suppliers reside for various categories of risk. In these columns, a lower decile indicates a higher level of risk. For example, COMPANY1 is in the decile with the highest risk in the risk categories of “INFO PROTECTION,” “REGULATORY,” and “GEOGRAPHIC PRESENCE.” “BUSINESS CONTINUITY” represents a relatively low category of risk for COMPANY1 when compared to the other risk categories. In certain embodiments, GUI 300 may also display the raw risk score associated with various categories of risk.

Pull-down menu 312 allows a user to change the line of business (e.g., the organization) for which the risk assessment is created. In the depicted embodiment, GUI 300 displays risk-related information for suppliers to all organizations that fall under the SERVICING line of business in a larger organization. A user may select a different line of business under pull-down menu 312. In certain embodiments, the user may have the option to limit the display to suppliers included in various categories (i.e., sub-categories) situated within the line of business.

Modifications, additions, or omissions may be made to GUI 300 without departing from the scope of the invention. For example, columns 310 may include other categories (including sub-categories of risk). Additionally, GUI 300 may include columns indicating information associated with the money spent (or projected to be spent) by one or more organizations. This information could be total money spent by particular organizations, an indication of which organizations (e.g., sub-organizations) spent the most money with the supplier, and/or any other suitable information. As another example, GUI 300 may include another pull-down menu that allows a user to view only suppliers from particular industry category (including sub-categories).

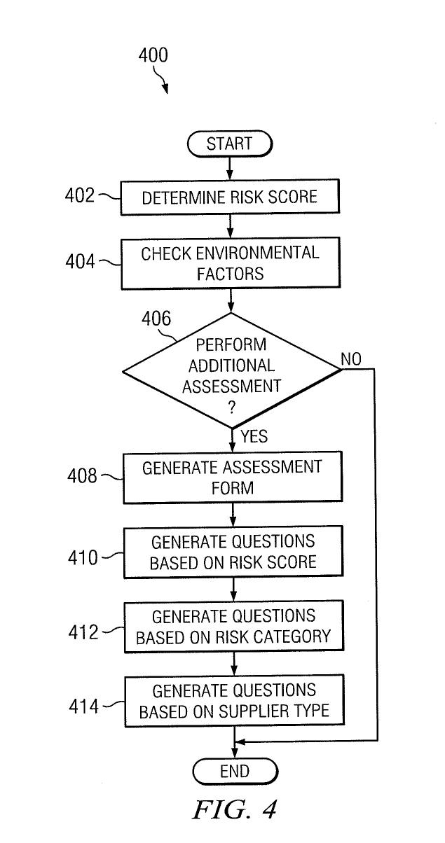

FIG. 4 illustrates an exemplary method 400 for generating risk information associated with a supplier to an organization.

At step 402, a risk score is calculated for a supplier, for example, by risk assessment module 112. This risk score may be calculated by any of the methods disclosed herein. In certain embodiments, environmental factors associated with the supplier are checked. The environmental factors may be periodically monitored until a change is detected. At step 406, the method determines whether an additional assessment should be performed on the supplier. This may be determined by risk assessment module 112, for example, according to the risk score and/or environmental factors associated with the supplier as well as any other suitable factor. If no additional assessment will be performed, the method ends.

If an additional assessment will be performed, the method proceeds with step 408 where risk information associated with the supplier is created. At step 408, a form is created for use in the additional assessment. In certain embodiments, the method populates the form with information known about the supplier, such as contact name, industry category, and/or any other suitable information. The remaining steps generate additional criteria (e.g., questions) for which selections associated with the supplier will be made. For example, questions based on the risk score are generated in step 410. These questions may be selected because of a total risk score. At step 412, risk assessment module 112 generates questions based on scores associated with certain risk categories (including risk sub-categories). At step 414, risk assessment module 112 generates questions based on the type of supplier undergoing the additional risk assessment. In certain embodiments, the questions generated in steps 410, 412, and 414 are selected from a list of all possible questions.

Modifications, additions, or omissions may be made to method 400 disclosed herein without departing from the scope of the invention. For example, the questions selected for inclusion in the risk information may depend on multiple factors such as both a risk category and the supplier type. The methods may include more, fewer, or other steps. For example, the method may include an additional step where questions are generated based on the type of organization being supplied the goods and/or services of the supplier. As another example, the method may include an additional step where questions are generated based on the environmental factors associated with the organization. Additionally, steps may be performed in parallel or in any suitable order. For example, the method may generate the questions of step 410 before generating the assessment form in step 408.

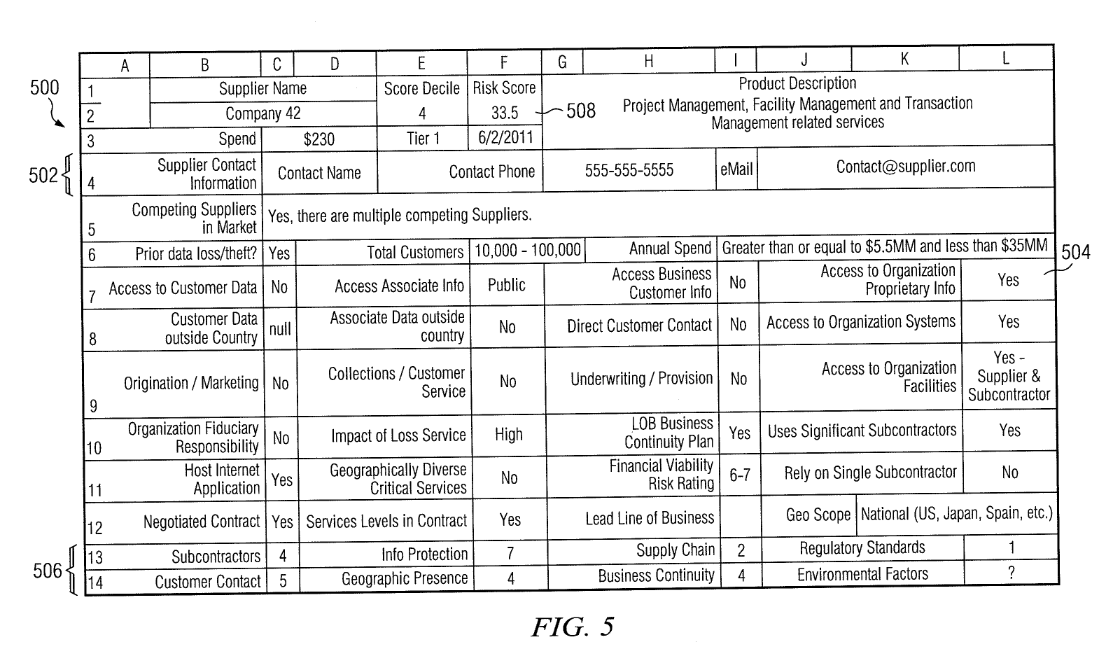

FIG. 5 is an exemplary embodiment of information 500 used in performing an additional assessment of a supplier. In certain embodiments, information 500 may be an example of a portion of risk information 110 of FIG. 1. Information 500 includes certain information automatically populated using existing knowledge gained from data 106 or any other suitable information source. For example, the content of row 502 includes contact information for a supplier. As another example, field 504 includes a selection made by the supplier that indicates that the supplier has access to proprietary information of the organization. Information 500 also includes information derived or calculated based on the selections in data 106, such as the deciles in which the supplier resides for certain risk categories (shown in rows 506) and a total risk score for the supplier (shown in field 508).

Modification, additions, or omissions may be made to information 500. For example, information 500 may include actual scores associated with risk categories instead of or in addition to the decile in which the supplier resides for that category.

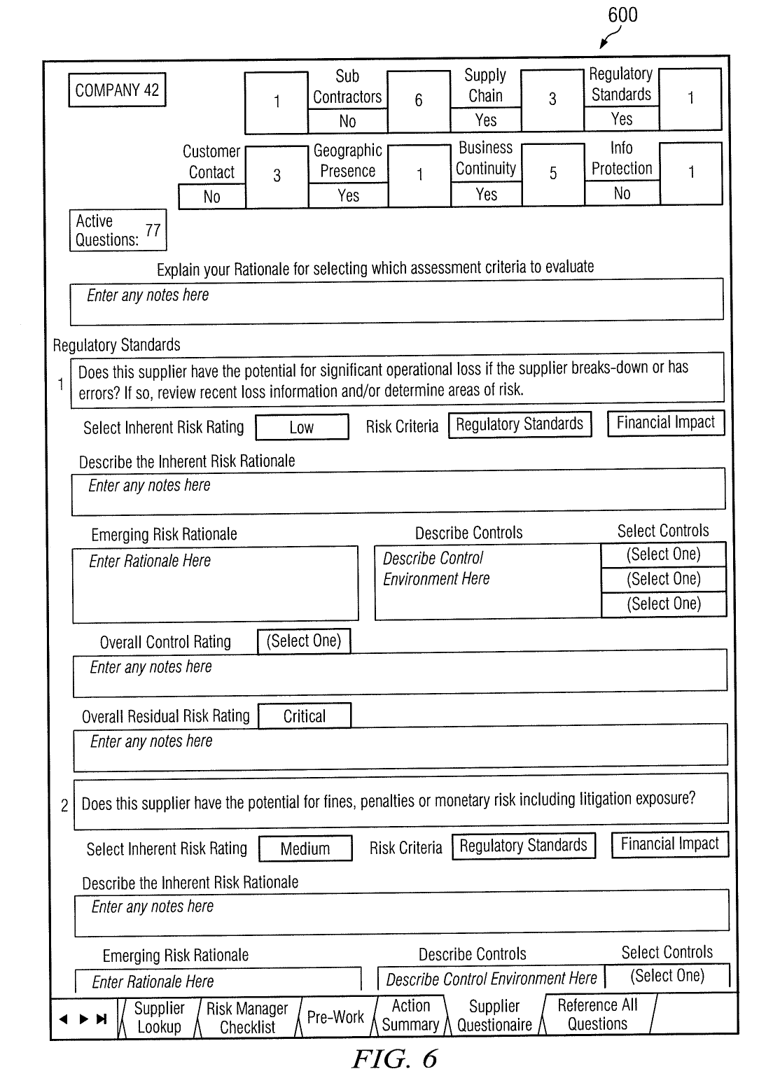

FIG. 6 is an exemplary embodiment of information 600 used in performing an additional assessment of a supplier. In certain embodiments, information 600 may be an example of a portion of risk information 110 of FIG. 1. Information 600 includes additional criteria to be assessed for a supplier after generation of an initial risk score. For example, information 600 includes questions associated with the regulatory standards risk category because the supplier had a high risk score in that risk category. Information 600 may include questions associated with any other suitable category. In certain embodiments of information 600, such as the embodiment depicted, information 600 is generated to assist an associate of the organization to perform the additional assessment. In addition to an associate of the organization, information 600 may also be generated for completion by an associate of the supplier or for any other suitable party. In certain embodiments, risk assessment module 112 may automatically answer certain questions included in information 600 by accessing various information sources such as third party information source 108 of FIG. 1.

Modifications, additions, or omissions may be made to information 600. For example, information 600 may include questions associated with environmental factors, the supplier's total risk score, supplier type, the type of organization for which the supplier provides goods and/or services, and/or any other suitable factor.

Certain embodiments of the invention may provide one or more technical advantages. A technical advantage of one embodiment allows an organization to determine the risk associated with utilizing the goods and/or services of a supplier. For example, a banking organization may determine the risk of using a software services supplier across the various lines of business within the bank. Another technical advantage of an embodiment allows an organization to ensure that its suppliers comply with the organization's policies and other applicable regulations, standards, and processes. Another technical advantage of an embodiment allow for forecasting risk associated with a supplier before engaging that supplier to provide goods and/or services for an organization. Another technical advantage of an embodiment allows an organization to utilize knowledge already in its possession to determine a risk associated with a supplier. The organization may then determine whether an additional risk assessment of the supplier is necessary.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A risk assessment module for assessing risk associated with a supplier of an organization, comprising:
a memory comprising rules associated with calculating risk scores; and
a processor communicatively coupled to the memory and operable to:
access the rules;
identify a supplier associated with an organization for risk assessment, wherein the risk assessment comprises a plurality of questions, each question having a priority level;
determine a plurality of selections for the supplier associated with the plurality of questions, wherein a respective selection of the plurality of selections is associated with a respective question of the plurality of questions;
determine a plurality of values associated with the plurality of selections, wherein a respective value of the plurality of values is associated with a respective selection of the plurality of selections;
monitor an environmental factor associated with the supplier; and
calculate a risk score for the supplier according to the plurality of values and the priority level of each of the plurality of questions.

2. The module of claim 1, wherein the processor is further operable to identify the supplier by determining that the organization has spent money with the supplier.

3. The module of claim 1, wherein the processor is further operable to detect a change in the environmental factor.

4. The module of claim 1, wherein the processor is further operable to calculate the risk score for the supplier according to a subset of the plurality of selections, wherein each of the selections included in the subset are associated with a particular risk category.

5. The module of claim 1, wherein the processor is further operable to:
calculate a second risk score for a second supplier associated with the organization; and
determine a ranking of the first supplier and the second supplier according to the risk score and the second risk score.

6. The module of claim 1, wherein the processor is further operable to:
determine a first value associated with one of the plurality of selections;
calculate the risk score for the supplier based at least in part on the first value;
replace the first value associated with one of the plurality of selections with a second selection; and
modify the risk score for the supplier based at least in part on the second value.

7. A method for assessing risk associated with a supplier of an organization, comprising:
identifying a supplier associated with an organization for risk assessment, wherein the risk assessment comprises a plurality of questions, each question having a priority level;
determining a plurality of selections for the supplier associated with the plurality of questions, wherein a respective selection of the plurality of selections is associated with a respective question of the plurality of questions;
determining a plurality of values associated with the plurality of selections, wherein a respective value of the plurality of values is associated with a respective selection of the plurality of selections;
monitoring, using a processor, an environmental factor associated with the supplier; and
calculating, using the processor, a risk score for the supplier according to the plurality of values and the priority level of each of the plurality of questions.

8. The method of claim 7, wherein identifying the supplier comprises determining that the organization has spent money with the supplier.

9. The method of claim 7, wherein one of the plurality of selections comprises an absence of information, the method further comprising determining a value associated with the absence of information.

10. The method of claim 7, further comprising detecting a change in the environmental factor.

11. The method of claim 7, further comprising monitoring an environmental factor associated with the supplier, wherein the environmental factor comprises an audit result of a procedure practiced by the supplier.

12. The method of claim 7, wherein the risk score for the supplier is calculated according to a subset of the plurality of selections, wherein each of the selections included in the subset are associated with a particular risk category.

13. The method of claim 7, further comprising:
calculating a second risk score for a second supplier associated with the organization; and
determining a ranking of the first supplier and the second supplier according to the risk score and the second risk score.

14. The method of claim 7, further comprising:
determining a first value associated with one of the plurality of selections;
calculating the risk score for the supplier based at least in part on the first value;
replacing the first value associated with one of the plurality of selections with a second selection; and
modifying the risk score for the supplier based at least in part on the second value.

15. A non-transitory computer readable medium comprising logic, the logic when executed by a processor, operable to:
identify a supplier associated with an organization for risk assessment, wherein the risk assessment comprises a plurality of questions, each question having a priority level;
determine a plurality of selections for the supplier associated with the plurality of questions, wherein a respective selection of the plurality of selections is associated with a respective question of the plurality of questions;
determine a plurality of values associated with the plurality of selections, wherein a respective value of the plurality of values is associated with a respective selection of the plurality of selections;
monitor an environmental factor associated with the supplier; and
calculate a risk score for the supplier according to the plurality of values and the priority level of each of the plurality of questions.

16. The computer readable medium of claim 15, wherein the logic is further operable to identify the supplier by determining that the organization has spent money with the supplier.

17. The computer readable medium of claim 15, wherein the logic is further operable to detect a change in the environmental factor.

18. The computer readable medium of claim 15, wherein the logic is further operable to calculate the risk score for the supplier according to a subset of the plurality of selections, wherein each of the selections included in the subset are associated with a particular risk category.

19. The computer readable medium of claim 15, wherein the logic is further operable to:
calculate a second risk score for a second supplier associated with the organization; and
determine a ranking of the first supplier and the second supplier according to the risk score and the second risk score.

20. The computer readable medium of claim 15, wherein the logic is further operable to:
determine a first value associated with one of the plurality of selections;
calculate the risk score for the supplier based at least in part on the first value;
replace the first value associated with one of the plurality of selections with a second selection; and
modify the risk score for the supplier based at least in part on the second value.

21. A risk assessment module for generating supplier risk assessment information, comprising:
a memory comprising rules associated with generating risk assessment information; and
a processor communicatively coupled to the memory and operable to:
access the rules;
determine a risk score for a supplier associated with an organization according to a plurality of selections associated with a plurality of questions in a risk assessment;
determine that the supplier should be evaluated in an additional assessment;
select a plurality of additional questions according to the risk score; and
generate an assessment form for the additional assessment that includes the plurality of additional questions.

22. The risk assessment module of claim 21, wherein the processor is further operable to automatically populate the assessment form with information derived from the plurality of selections associated with the plurality of questions in the risk assessment.

23. The risk assessment module of claim 21, wherein the processor is further operable to select one of the plurality of additional questions based on a particular risk category.

24. The risk assessment module of claim 21, wherein the processor is further operable to select one of the plurality of additional questions based on an environmental factor associated with the supplier.

25. The risk assessment module of claim 21, wherein the processor is further operable to select one of the plurality of additional questions based on a type associated with supplier.
